(19) United States
(12) Patent Application Publication
(10) Pub. No.: US 2004/0076316 A1
(43) Pub. Date: Apr. 22, 2004

(54) Method and apparatus for measuring physiology by means of infrared detector

(76) Inventor: Mark A Fauci, Patchogue, NY (US)

Correspondence Address: DARBY & DARBY P.C., P. O. BOX 5257, NEW YORK, NY, 10150-5257, US

(21) Appl. No.: 10/450,588

(22) PCT Filed: Dec. 17, 2001
(86) PCT No.: PCT/US01/48964

(30) Foreign Application Priority Data
Dec. 15, 2000 (US) 60255835

(51) Int. Cl. G06K 9/00

(52) U.S. Cl. 382/128

(57) ABSTRACT

An infrared camera provides a series of infrared images frames of a part of the human body. A preferred camera is equipped with a focal plane array of GaAs quantum-well infrared photodetectors (QWIP). The infrared images are transmitted to a processor which processes each image into a multiplicity of small sub-areas. In each sub-area, temperature variation is measured over time and the temperature variation in the sub-area is represented as a temperature code. The temperature codes are then displayed as colors in each sub-area in a display of the infrared image. An observer is thereby able to monitor and analyze the physiology of the body. In a preferred embodiment, physiological changes of the brain are observed as different parts of the brain function.

### FIELD OF THE INVENTION

The present invention relates generally to a method and apparatus for monitoring the body and, more particularly, concerns a method and apparatus for using an infrared detector to monitor and analyze tissue and organ blood flow and physiology in the brain and other parts of the body.

### BACKGROUND OF THE INVENTION

Dynamic Area Telethermometry (DAT) is a known concept and described fully in the 1991 publication of Dr. Michael Anbar, Thermology 3 (4):234-241, 1991. It is a non-invasive, functional test of the autonomic nervous system, that monitors changes in the spectral structure and spatial distribution of thermoregulatory frequencies (TRF's) over different areas of the human skin. Grounded in the science of blackbody infrared radiation as measured by infrared imaging, DAT derives information on the dynamics of heat generation, transport, and dissipation from changes in the temperature distribution over areas of interest. Changes can be detected in the average temperatures of area segments or in the variances of those averages; the variances measure the homogeneity of the temperature distribution and, therefore, the homogeneity of cutaneous perfusion. As shown by Dr. Anbar in the European J Thermology 7:105-118, 1997, under conditions of hyperperfusion the homogeneity reaches a maximum and the amplitude of its temporal modulation is at a minimum. From the periodic changes in temperature distribution over different skin areas, the thermoregulatory frequencies of the processes that control the temperature in the given areas can be derived.

DAT is useful in the diagnosis and management of a large variety of disorders that affect neurological or vascular function. DAT is used to measure the periodicity of changes in blood perfusion over large regions of skin so as to identify a locally impaired neuronal control, thereby providing a quick and inexpensive screening test for skin cancer and for relatively shallow neoplastic lesions, such as breast cancer. The different clinical applications of DAT are fully described by Dr. Michael Anbar in 1994 in a monograph entitled “Quantitative and Dynamic Telethermometry in Medical Diagnosis and Management”, CRC Press Inc. September, 1994.

U.S. Pat. No. 5,810,010, No. 5,961,466 and No. 5,999,843, all granted to Michael Anbar, the first patent being licensed and the remaining patents being assigned to the assignee of the present patent application, relate to methods and apparatus for cancer detection involving the measurement of temporal periodic changes in blood perfusion, associated with immune response, occurring in neoplastic lesions and their surrounding tissues. Particularly, the method for cancer detection involves the detection of non-neuronal thermoregulation of blood perfusion, periodic changes in the spatial homogeneity of skin temperature, aberrant oscillations of spatial homogeneity of skin temperature and aberrant thermoregulatory frequencies associated with periodic changes in the spatial homogeneity of skin temperature. The disclosures of these three patents are incorporated by reference herein in their entirety.

According to a preferred embodiment of the present invention, an infrared camera provides a series of infrared images (frames) of a portion of the human body. A preferred camera is equipped with a focal plane array of gallium arsenide quantum-well infrared photodetectors (QWIP). Such a camera can record modulation of skin temperature and its homogeneity with a precision greater than ±15 millidegrees C. The infrared images are transmitted to a processor which processes the image into a multiplicity of small sub-areas. In each sub-area, temperature variation is measured over time and the temperature variation in the sub-area is represented as a temperature code. The temperature codes are then displayed as colors which are displayed in each sub-area in a display of the infrared image. An observer is thereby able to monitor and analyze the physiology of the body. In a preferred embodiment, physiological changes of the brain are observed while different parts of the brain function. However, it will be appreciated that the present invention provides a useful device for cancer detection, comparable to DAT devices.

### BRIEF DESCRIPTION OF THE DRAWINGS

The foregoing brief description, as well as further objects, features and advantages of the present invention will be understood more completely from the following detailed description of the present invention, with reference being had to the accompanying drawings in which:

FIG. 1 is a block diagram illustrating both the method and operation of the apparatus of the present invention;

FIG. 2 is a copy of a computer screen illustrating an infrared image of a human brain and the use of a computer program for selection of a portion of that image to be processed in accordance with the present invention;

FIG. 3 is a graph of temperature versus time in a sub-area of the infrared image during a ten second (2000 frame) interval, the temperature being estimated by a best-fit line;

FIG. 4 is a graph similar to FIG. 3 showing best-fit lines for various sub-portions of the ten second interval;

FIG. 5 is a graph similar to FIG. 3 illustrating various portions of the graph being fitted in a piecewise fashion with different best-fit lines;

FIG. 6 is a processed image illustrating the average temperature of the infrared image over an entire set of frames;

FIGS. 7, 8 and 9 are processed images of the brain of the same subject showing brain activity during toe movement, tongue movement and wrist movement, respectively;

FIG. 10 is a processed image for a patient who is having a seizure;

FIG. 11 is a temperature waveform diagram illustrating a method for estimating temperature variation in real time; and

FIG. 12 is a flowchart useful in explaining the method employed in FIG. 11.

### DETAILED DESCRIPTION OF THE PREFERRED EMBODIMENT

Turning now to the details of the preferred embodiment, there will be described a system and method which are used to generate processed images based on images of the brain collected during surgery. When processed in accordance with the invention, the images clearly reveal blood flow as well as physiological changes that occur as different parts of the brain perform functions. The latter is the result of changes in blood perfusion, infrared emissions as the result of changes in metabolic behavior and/or the result of brain chemical or electrochemical changes that occur during or as a result of brain function. Those skilled in the art will appreciate that the method and apparatus can be applied to any organ or tissue, other than the brain. One value of the preferred embodiment is that it maps areas which are activated in tissue or organs during normal activity, and this information can later be used to distinguish between healthy and diseased tissues or organs. The data can be presented as static images or an animation that illustrates changes with time.

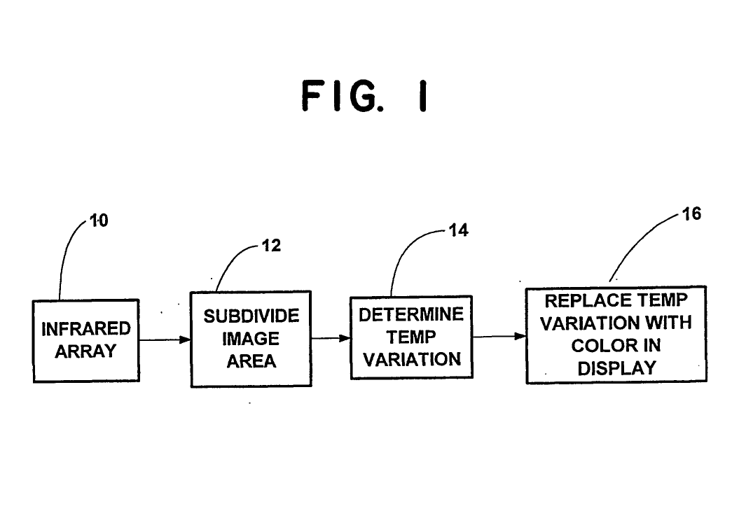

FIG. 1 is functional block diagram which is representative of both the apparatus and method of the invention. In an infrared camera, an array 10 of QWIP infrared sensors is used to form an infrared image of the brain during an operation. The array preferably includes 256 by 256 sensors and captures images at a frame rate of 200 frames per second. Preferably, the brain is imaged for 10 seconds. In the preferred embodiment, the resulting infrared image data is saved to the hard drive a computer.

At block 12, each infrared frame is then broken up into thousands of individual sub-areas over the entire image area (preferably each sub-area is 2×2 pixels). At block 14, the temperature variation in each sub-area is determined over some period of time and saved as a code for that area. At block 16, the codes for the various sub-areas are displayed in those sub-areas as a color. In the preferred embodiment, the codes represent the slope of a best-fit line representing the temperature variation over a period of time.

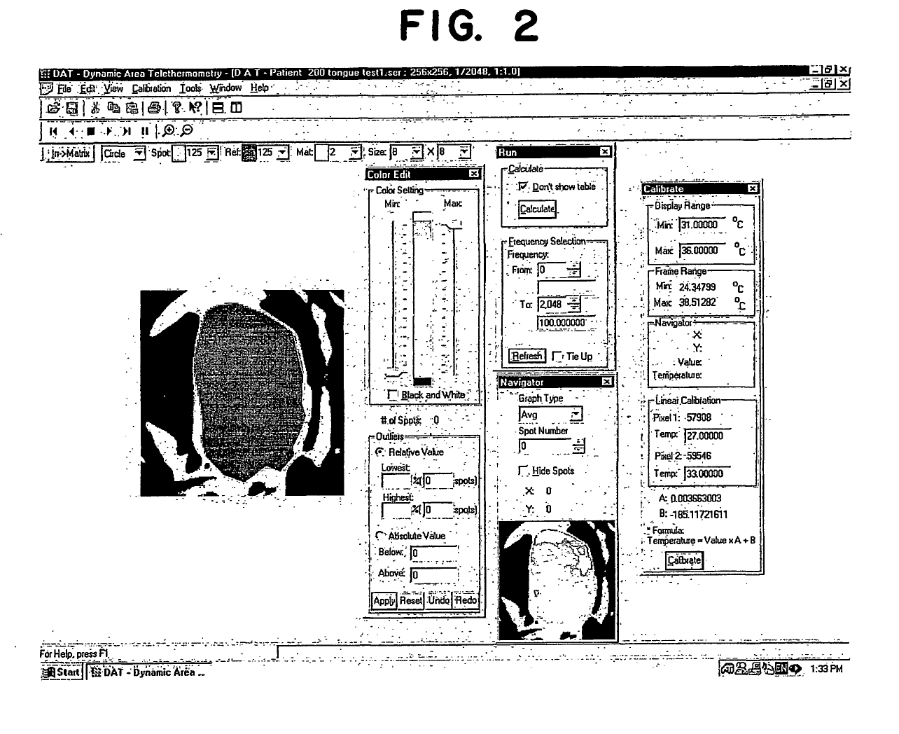

FIG. 2 is a screen print of a screen of computer program utilized to process the infrared images of the brain. The infrared image of the brain 20 shows the temperature of the brain through a spectrum of colors ranging from black, through green, to red and. Finally to white. As an initial step, an area 22 of the image to be analyzed is (shown in red) selected in the display of one of the frames. In the process, the operator is also able to select the range of temperatures to be displayed, in this case 31-36° C. The selected area is then broken down into the individual sub-areas.

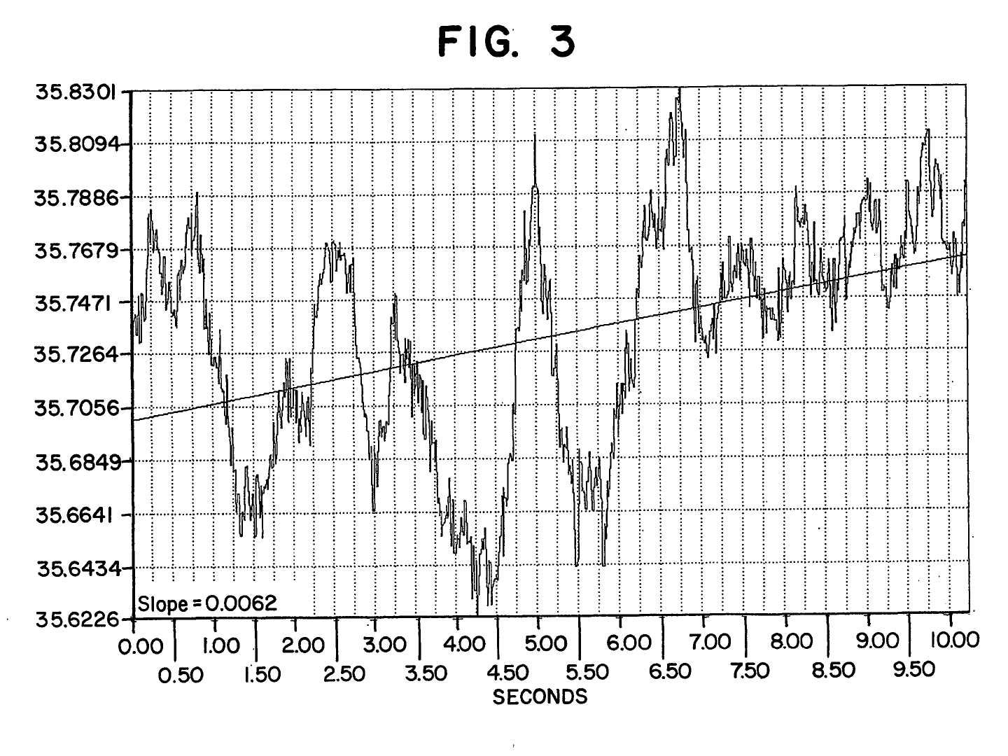

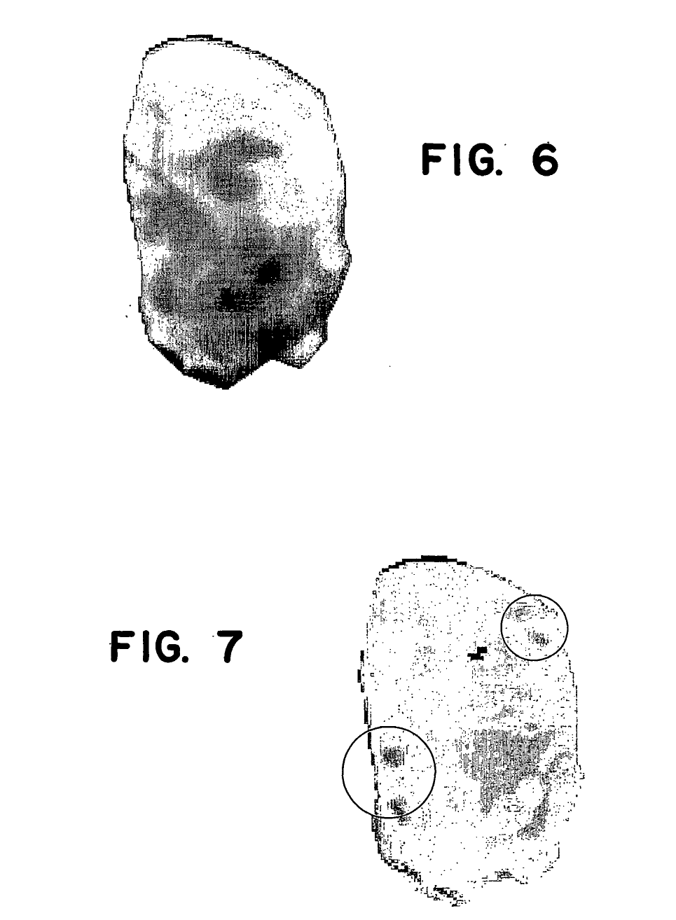

FIG. 3 illustrates the variation of temperature over a 10 second interval of frames (2,000 frames) in a particular sub-area. FIG. 3 also illustrates a line 24, which is a best-fit line for the entire waveform shown in FIG. 3. In the preferred embodiment, such a best-fit line is generated for each sub-area, and a code is generated for each sub-area representing the slope of the best-fit line for that sub-area. Each code is then converted to a color, and that color is superimposed on the sub-area in a display of the entire image. Color images such as FIGS. 6-10 result.

FIG. 6 illustrates an image, in grey scale rendering, showing the average temperature over the entire set of frames. This image reveals some information regarding vascular structure.

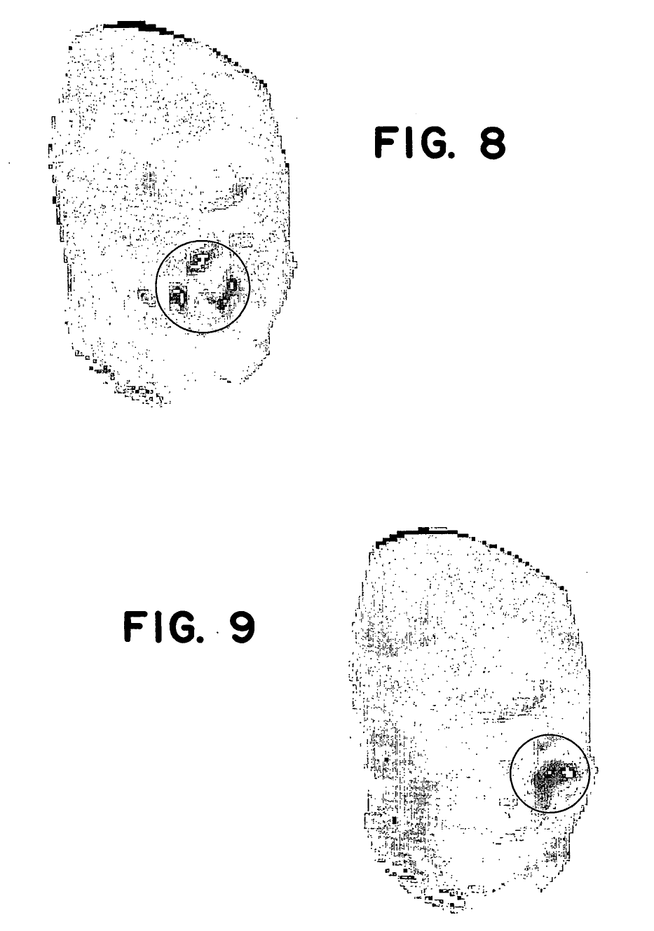

FIGS. 7, 8 and 9 are grey scale rendered images of the same subject taken while performing toe, tongue and wrist movement, respectively. In each instance, circles have been drawn around the portions of the brain involved in the respective movement. By taking images such as this, it becomes possible to map various activities of a patient to different areas of the brain. When malfunctions occur, the doctor would then know which portion of the brain to observe when analyzing a patient.

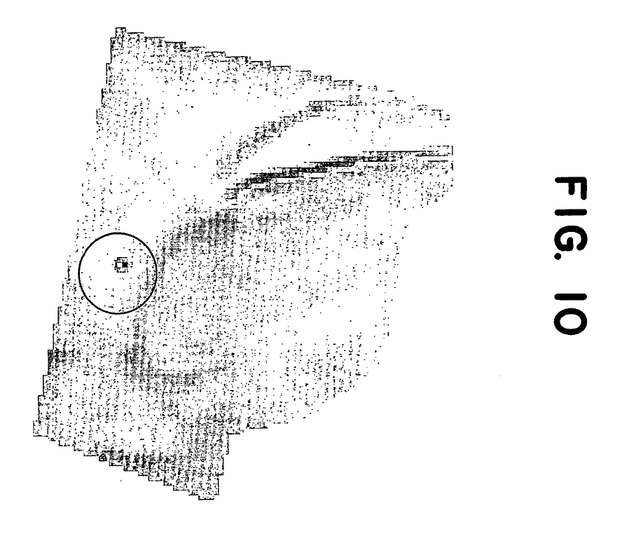

FIG. 10 illustrates the brain of a patient undergoing a seizure. It should be noted that the area of elevated cellular metabolic activity can be virtually pin-pointed.

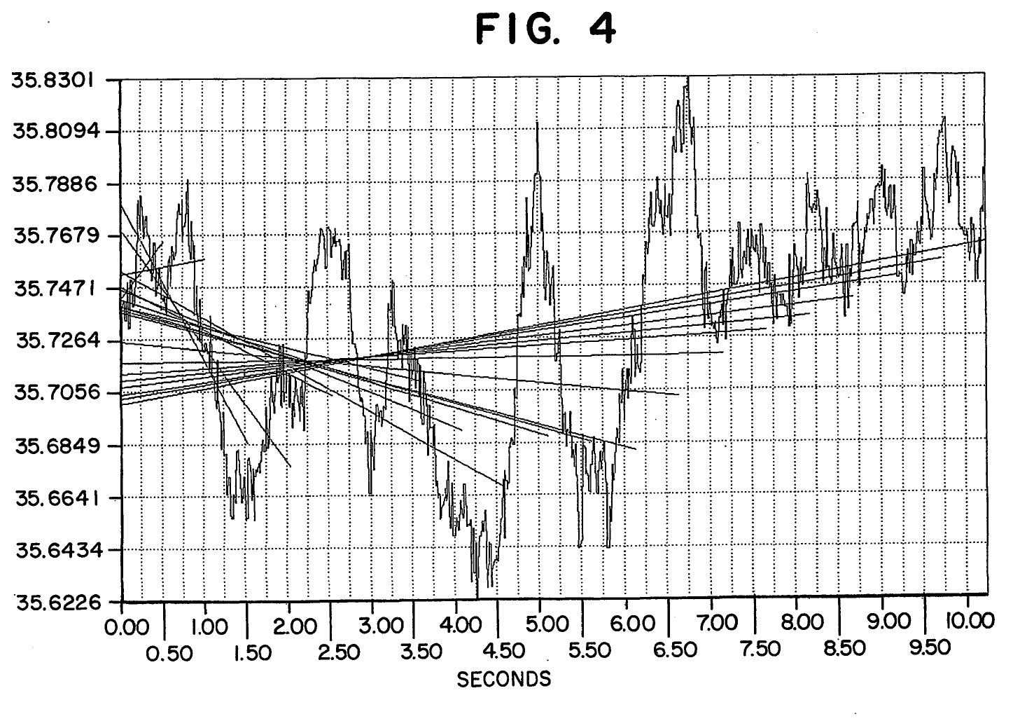

FIG. 4 illustrates the same waveform of FIG. 3 and shows not only the best fit line 24 corresponding to the full 10 seconds, but shows progressively shorter best-fit lines corresponding to progressively shorter intervals of the waveform. It will be appreciated that rather than having a “still” as shown in FIGS. 6-10, it would be possible to have a series of stills or a “video” with successive images illustrating the color corresponding to the code of a successively longer line in FIG. 4. The series of images would then correspond to a video of the brain as its activity changes during different movements or situations.

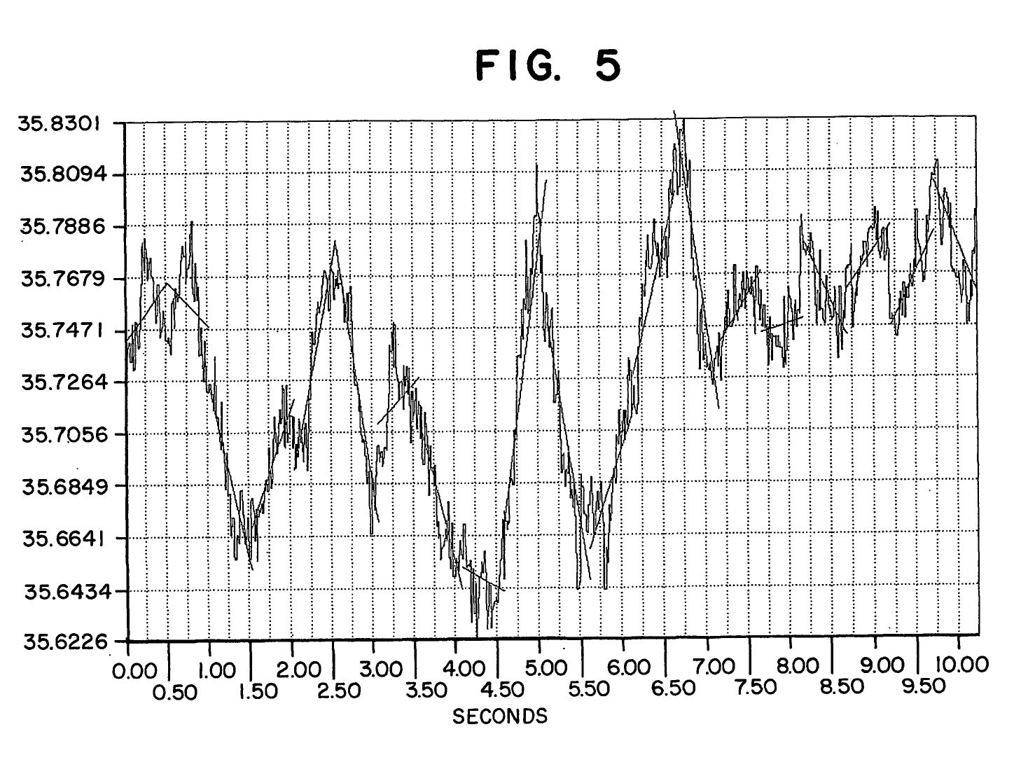

FIG. 5 again shows the waveform of FIGS. 3 and 4, but this time being estimated in piecewise fashion by a series of lines 26a, 26b, 26c, 26d, 26e, 26f etc. In this case, the waveform is estimated by a different best-fit line segment during each 0.5 second interval, and the slopes of those line segments would provide a sequence of codes to be displayed as colors in the corresponding sub-area of the image, yielding a video.

The preferred embodiment has been illustrated as a system in which a display of portion of the body is produced by using temperature variation codes to affect the color of portions of the display. However a useful diagnostic device could be produced without a viewable display. For example, the infrared sensor could view a very small area, such as a spot or blemish on the skin, and a temperature variation code could be generated as an indication of the state of the scanned spot (e.g., presence or absence of cancer). The value of the code itself could be the output of the device. Alternately, the code could be compared to a threshold and an indication produced, based upon the comparison.

The preferred embodiment has been illustrated as a system in which the video information is stored on a hard drive and then processed to reveal the processed image. Where the processed image is a video, the delay involved in this type of processing would be undesirable, since the video would not be real time. However, the best quality graphics cards available today would yield a video which is virtually real time. Those skilled in the art will appreciate that readily available processing techniques, such as the use of multi-processor computers and parallel processing could produce results that would be indistinguishable from real time video.

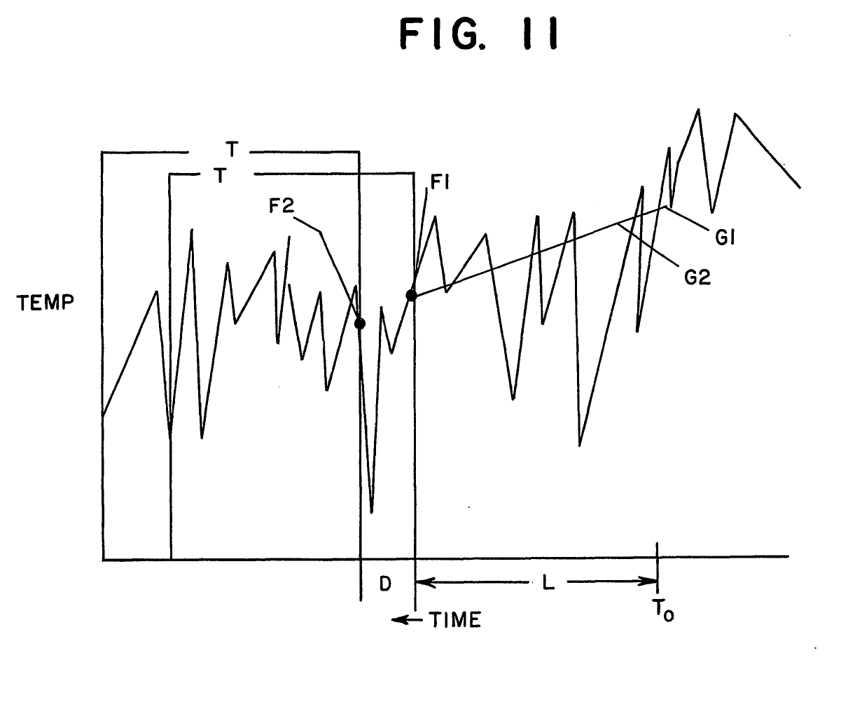

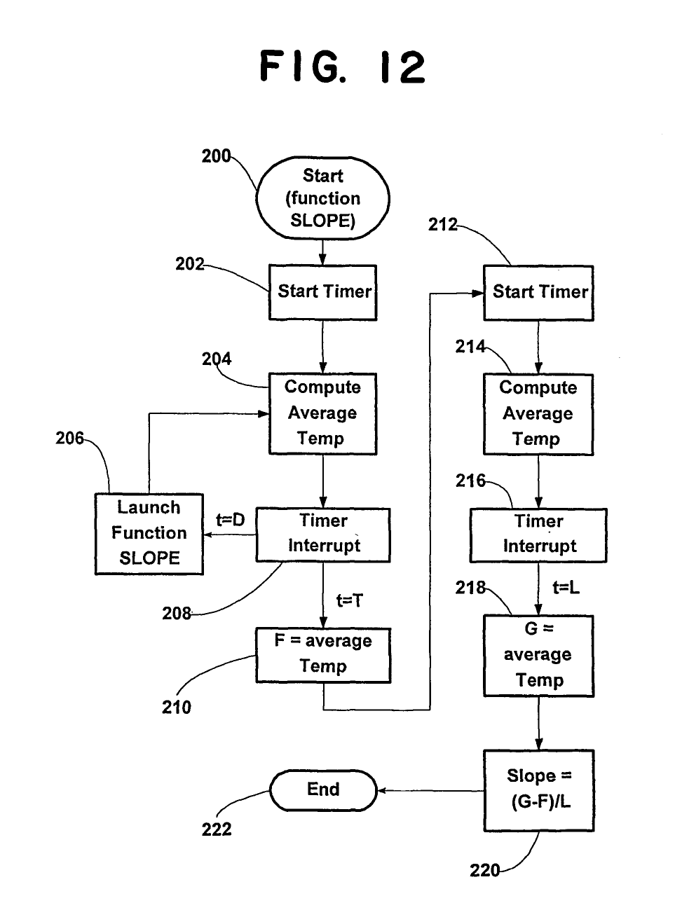

FIG. 11 illustrates an alternate method for computing temperature slope codes which will produce real time video on virtually any computer, and FIG. 12 is a flowchart useful in describing the method as performed by a computer, in the form of a function SLOPE .

FIG. 11 shows the variation of temperature with time in a particular sub-area starting at time T₀. Initially, an operator selects three values D, T and L. D is the rate at which new slope codes are produced and would be selected to achieve a particular video frame rate, such as 15-30 frames per second. T and L are the processing intervals, preferably in the range of 10 seconds, discussed further below. Function SLOPE starts at block 200, with a timer being set (block 202) at time T₀ and the average temperature being computed (block 204). Should the timer measure an interval D, temperature averaging is interrupted (block 208), and a second version of function SLOPE is launched (block 206), temperature averaging resumes. Should the timer measure an interval T, temperature averaging is interrupted (block 208), and the variable F stores the temperature average (block 210 and point F1).

A timer is then started (block 212) and computation of a new temperature average begins (block 214). When the timer measures an interval L, temperature averaging is interrupted (block 216), and the variable G stores the temperature average (block 218 and point G1). At block 220, temperature slope is then determined as the slope of a line between the two averages F and G, the slope of the line connecting points F1 and G1, and the function SLOPE terminates (block 222).

In the mean time, the additional instances of the function SLOPE that were launched continue their processing to completion. For example, a second slope value is produced with respect to points F2 and G2, following an interval D after the first slope value is produced. The overall effect is that, after an initial delay of T+L, a new slope value is produced for each sub-area at the conclusion of every interval D.

Although preferred embodiments of the invention have been disclosed for illustrative purposes, those skilled in the art will appreciate that many additions, modifications and substitutions are possible, without departing from the scope and spirit of the invention as defined by the accompanying claims.

What is claimed:

1. A method for measuring the physiology of a living body, comprising the steps of:
forming an infrared image of a portion of the body;
sub-dividing the infrared image area into a plurality of sub-areas;
measuring temperature variation over time in a sub-area and generating a temperature code corresponding to the sub-area, which is representative of the temperature variation in the sub-area; and
creating an image of the portion of the body in which a sub-area is represented by a visual feature which is unique to the temperature code corresponding to the sub-area.

2. The method of claim 1 in which the visual feature is the color of the sub-area.

3. The method of claim 1, wherein temperature variation over time is estimated by the slope of a line estimating temperature variation during a predefined interval.

4. The method of claim 3, wherein the interval is 10 seconds.

5. The method of claim 1, wherein the infrared image is formed with a focal plane array of gallium arsenide quantum-well infrared photodetectors.

6. The method of claim 5, wherein the array includes 256×256 photodetectors and captures infrared images at the rate of 20 frames per second.

7. The method of claim 1, wherein the created image is static.

8. The method of claim 1, wherein the created image is a moving image.

9. An apparatus for measuring the physiology of a living body, comprising:
an infrared camera forming an infrared image of a portion of the body;
a splitter sub-dividing the infrared image area into a plurality of sub-areas;
a temperature processor measuring temperature variation over time in a sub-area and generating a temperature code corresponding to the sub-area, which is representative of the temperature variation in the sub-area; and
a display processor creating an image signal effective to produce an image of the portion of the body on a display device in which a sub-area is represented by a visual feature which is unique to the temperature code corresponding to the sub-area.

10. The apparatus of claim 9 in which the visual feature is the color of the sub-area on the display.

11. The apparatus of claim 9, wherein temperature processor estimates variation over time by the slope of a line estimating temperature variation during a predefined interval.

12. The apparatus of claim 11, wherein the interval is 10 seconds.

13. The apparatus of claim 9, wherein the camera comprises a focal plane array of gallium arsenide quantum-well infrared photodetectors on which the infrared image is formed.

14. The apparatus of claim 13, wherein the array includes 256×256 photodetectors and the camera captures infrared images at the rate of 20 frames per second.

15. The method of claim 9, wherein the camera image is static.

16. The method of claim 9, wherein the camera image is a moving image.

17. A method for measuring the physiology of a living body, comprising the steps of:
forming an infrared image of a portion of the body;
measuring temperature variation over time in a sub-area of the image and generating a temperature code corresponding to the sub-area, which is representative of the temperature variation in the sub-area; and
Using the code as a physiological indication.

18. An apparatus for measuring the physiology of a living body, comprising:
an infrared camera forming an infrared image of a portion of the body;
a temperature processor measuring temperature variation over time in a sub-area and generating a temperature code corresponding to the sub-area, which is representative of the temperature variation in the sub-area; and
a display processor creating a signal effective to produce a viewable representation of the code as a physiological indication.

19. The method of any one of claims 1 or 17 wherein the measuring step is performed by:
(a) determining the average temperature in the sub-area for an interval T, and storing the average in a variable F;
(b) determining the average temperature in the sub-area for an interval L, and storing the average in a variable G;
(c) determining the temperature code as the slope of a straight line connecting the two averages, F and G; and
(d) repeating steps (a) through (c) upon conclusion of an interval D.

20. The apparatus of any one of claims 9 or 18, wherein the temperature processor:
(a) determines the average temperature in the sub-area for an interval T, and storing the average in a variable F;
(b) determines the average temperature in the sub-area for an interval L, and storing the average in a variable G;
(c) determines the temperature code as the slope of a straight line connecting the two averages, F and G; and
(d) repeats steps (a) through (c) upon conclusion of an interval D.
